(19) United States
(12) Patent Application Publication
(10) Pub. No.: US 2011/0248517 A1
(43) Pub. Date: Oct. 13, 2011

(54) SECURITY DEVICE FOR SLIDING CLOSURES

(76) Inventors: Susan Gornichec, Charlotte, NC (US); Robert A. Burnham, Charlotte, NC (US)

(21) Appl. No.: 12/756,330

(22) Filed: Apr. 8, 2010

(51) Int. Cl. E05B 65/08

(52) U.S. Cl. 292/262

(57) ABSTRACT

A security device is provided for securing a sliding closure movable in one direction against one aperture frame and movable in an opposite direction toward an opposed aperture frame. The security device includes a handle, a press bar, and a fulcrum component for interconnecting the handle and the press bar to one another. The press bar is disposable between the sliding closure and the opposed aperture frame. Also, the handle promotes release of the press bar from its disposition between the sliding closure and the opposed aperture frame when a force is applied to the handle and the handle is movable between a release ready position and a stowage position in the handle.

### BACKGROUND OF THE INVENTION

The present invention relates to a security device for sliding closures and, more particularly, to a security device operating in the manner of a jamb bar for selectively preventing a sliding movement of a sliding closure such as a sliding door or window.

U.S. Pat. No. 4,572,557 notes that sliding doors and windows are in widespread use today in building construction, and particularly in residential construction. According to U.S. Pat. No. 4,572,557, the relative ease with which these doors and/or windows can be “pried” or otherwise opened by unauthorized personnel has created a problem in maintaining the residence or other building secure against unauthorized entry. Among the devices that have been developed as a deterrent for locking these sliding doors and/or windows in the closed position are devices disclosed in Messina et al U.S. Pat. No. 3,825,290, issued Jul. 23, 1974, and entitled “Sliding Door Lock Bar Apparatus” and Tierney U.S. Pat. No. 4,073,522, issued Feb. 14, 1978, and entitled “Security Step or Stop for Slidable Door.” These devices have certain disadvantages, according U.S. Pat. No. 4,572,557, in that they are frequently of an expensive construction, and many are difficult to install, particularly in the case of an elderly or infirm individual living alone and wherein the cost of hiring installation personnel becomes a problem. According to U.S. Pat. No. 4,572,557, the Tierney U.S. Pat. No. 4,073,522 arrangement comprises a hinged bar adapted to be disposed in the track along which the door moves and is to be moved between an extended position and a “folded” position to provide alternate locked and unlocked positions for the door. The moving of the hinged bar into the locked position may require considerable downward force against the hinge element, particularly if the bar is to be wedged tightly enough to prevent unauthorized opening of the door. In addition, the “breaking” of the hinge element for folding of the bar to permit an opening of the door may be difficult, and requires stooping of the individual using the device. Additionally, according U.S. Pat. No. 4,572,557, the arrangement of Messina et al U.S. Pat. No. 3,825,290 a pair of rigid bars hingedly secured together and wherein one end of one of the bars is rigidly secured to a non-movable portion of the frame, and the outer end of the other bar is rigidly secured to the frame of the sliding panel or door. This arrangement generally reaches a solution to the problem, but has disadvantages in that the installation of the device is somewhat difficult and the overall construction of the device is somewhat impractical.

U.S. Pat. No. 7,290,371 notes that it is commonly known that sliding doors, such as sliding glass or window doors, are relatively easily displaced and removed from the outside of a building or room. This is true even though the door may be locked. As further noted by U.S. Pat. No. 7,290,371, it is known to cut a piece of wood to the desired length of the space between the moving sash and the casement that forms the surrounding framework of the closure. Such pieces serve to form a locking device. Such wooden locking devices are inserted between the closed sliding door sash and the casement of the door assembly. According to U.S. Pat. No. 7,290,371, this approach is helpful in that the known methods for easy displacement and removal of the sliding door are much more difficult or impossible without breaking the glass and removing the wooden strut locking device. Nonetheless, according to U.S. Pat. No. 7,290,371, such supplementary wooden strut locking devices lack ascetic appeal and are often a slight embarrassment for the homeowner. They also have no features which make storage convenient for the supplementary locking device and they serve no other purpose. Moreover, according to U.S. Pat. No. 7,290,371, these limitations are greater problems when the door is in frequent use between open and a double-locked condition (wherein both the regular door lock and the supplementary strut lock) are both desirably used and engaged. Thus, it is typical for the security strut to be stood in the corner or next to the door for ready use when the property owner is ready to leave the premises and again seeks to fully secure the structure.

Thus, there remains a long-felt need in this technical art for an improved, economical, easy-to-use and aesthetically pleasing security device that secures sliding doors, windows, and similar closures against unauthorized or undesired entry.

### SUMMARY OF THE INVENTION

According to one aspect of the present invention, there is provided a security device for securing a sliding closure movable in one direction against one aperture frame and movable in an opposite direction toward an opposed aperture frame. The security device includes a handle, a press bar, and a fulcrum component for interconnecting the handle and the press bar to one another.

According to a further feature of the one aspect of the present invention, the press bar is disposable between the sliding closure and the opposed aperture frame. Also, the handle promotes release of the press bar from its disposition between the sliding closure and the opposed aperture frame when a force is applied to the handle. Additionally, the fulcrum component is positionable between a first position relative to the press bar when the security device is in a sliding closure movement preventing position and a second position relative to the press bar when the security device in a stowage position, and the handle is movable between a release ready position in which the handle rests against a respective one of the sliding closure or the opposed aperture frame at a respective acute angle and a stowage position in the handle is at a lesser acute angle relative to the press bar than the respective acute angle of the handle relative to the respective one of the sliding closure or the opposed aperture frame when the security device is in its sliding closure movement preventing position.

In accordance with a further feature of the one aspect of the present invention, the fulcrum component includes a pivot element about which the handle pivots.

In accordance with a further additional feature of the one aspect of the present invention, the handle is formed of a substantially transparent material.

In accordance with an additional feature of the one aspect of the present invention, the handle is formed with a grip portion in the shape of an inverted letter “J”.

### BRIEF DESCRIPTION OF THE DRAWINGS

FIG. 1 is a perspective view of one embodiment of the security device of the present invention;

FIG. 2 is an exploded perspective view of one embodiment of the security device of the present invention illustrated in FIG. 1;

FIG. 3 is an enlarged perspective view of a portion of the security device illustrated in FIGS. 1 and 2;

FIG. 4 is a perspective view of a patio door in a closed position and showing the security device illustrated in FIGS. 1 and 2 in a door securing disposition;

FIG. 5 is a perspective view of the patio door shown in FIG. 4 in an open position and showing the security device illustrated in FIGS. 1 and 2 in a stowage disposition;

FIG. 6 is an enlarged perspective view of the security device illustrated in FIGS. 1 and 2 in a stowage disposition;

FIG. 7 is a perspective view of one embodiment of the security device of the present invention; and

FIG. 8 is a perspective view of the another embodiment of the security device of the present invention illustrated in FIG. 7.

### DETAILED DESCRIPTION

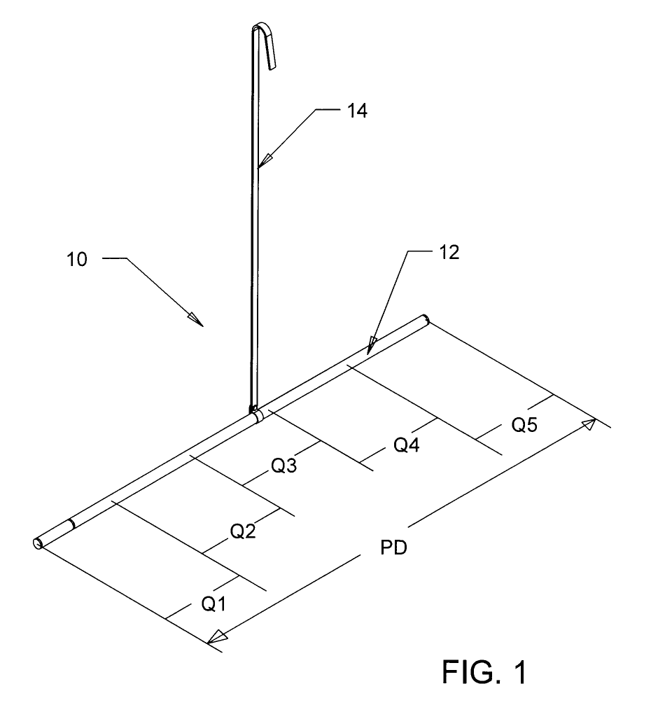

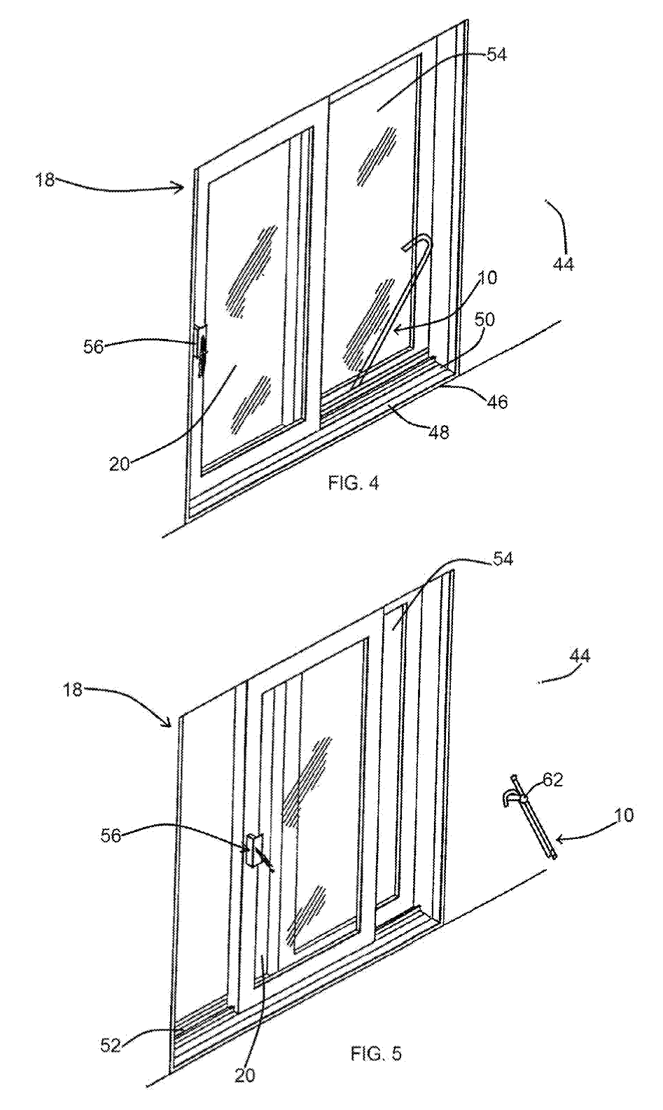

As illustrated in FIGS. 1-3, one embodiment of the security device of the present invention is illustrated and is generally denominated as the security device 10. The security device 10 includes a press bar 12 and a handle 14 movably secured to the press bar 12 by a fulcrum component in the form of a collar 16. As seen in FIG. 4, which is a perspective view of a patio door 18 in a closed position, the security device 10 is operable to secure a sliding door pane 20 of the patio door 18 against unauthorized or undesired efforts to slide the sliding door pane 20 from the closed position of the patio door 18 to an opened position. In addition to its role in preventing undesired opening of the sliding door pane 20, the security device 10 advantageously provides an easy release operation so that, when desired, the sliding door pane 20 of the patio door 18 can be slid to an open position, as is illustrated in FIG. 5. Moreover, the security device 10 is advantageously configured to be easily stowed or stored in readiness for deployment in a subsequent securing operation in which the security device 10 again secures the sliding door pane 20 against sliding from its closed position to its opened position.

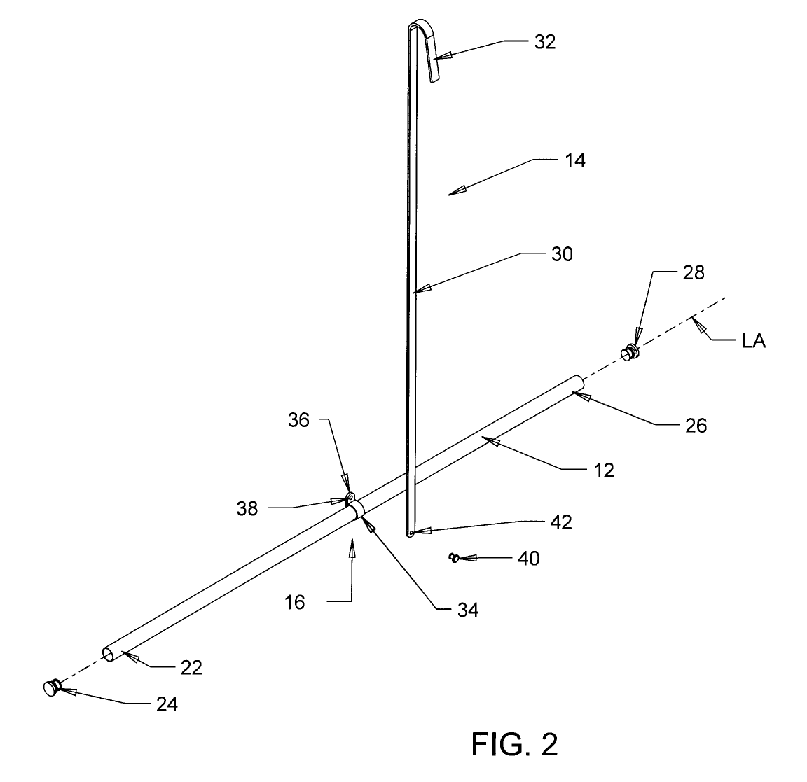

With reference now to FIG. 2, which is an exploded perspective view of the security device 10 shown in FIG. 1, the press bar 12 is preferably in the form of a cylindrical hollow or solid tube formed of a material such as, for example, steel, alloy steel, stainless steel, aluminum, a composite of such materials, or a composite of other materials with the materials being selected to preferably impart a relatively high resistance to failure when the press bar 12 is subjected to compressive forces along its lengthwise or longitudinal axis LA. One axial end 22 of the press bar 12 is provided with an end cap 24 and the opposed axial end 26 of the press bar is provided with an end cap 28. The end caps 24, 28 can be formed, for example, of a polymer or rubber material.

The handle 14 is formed of an elongate portion 30 and a grip portion 32 at one axial end of the elongate portion 30. The grip portion 32 of the handle 14 is formed such that a user's fingers can readily grip the grip portion 32. For example, as shown in FIG. 2, the grip portion 32 is formed in the shape of an inverted letter “J” with the “leg” extent of the inverted letter “J” being of a length to permit a user to wrap several fingers around this “leg” extent. The handle 14 may be formed of a metal, an alloy, fiberglass, hard rubber, or acrylic material but, in any event and as will be explained in more detail below, the elongate portion 30 of the handle 14 has a rigidity characteristic such that the handle 14, in the door securing position of the security device 10, extends upwardly from the press bar 12 and maintains the grip portion 32 at a conveniently accessible location for gripping by a user. The rigidity characteristic of the elongate portion 30 of the handle 14 thus can be understood as providing sufficient rigidity to the handle 14 for the convenient accessibility function but the range of acceptable rigidity of the elongate portion 30 of the handle 14 can nonetheless include, as desired, a rigidity that permits some flexure of the elongate portion 30. While the handle 14 may be formed as a homogenous component of a single material, the elongate portion 30 of the handle 14 may alternatively be formed of one material, or one combination of materials, while the grip portion 32 is formed of a different material, or a different combination of materials.

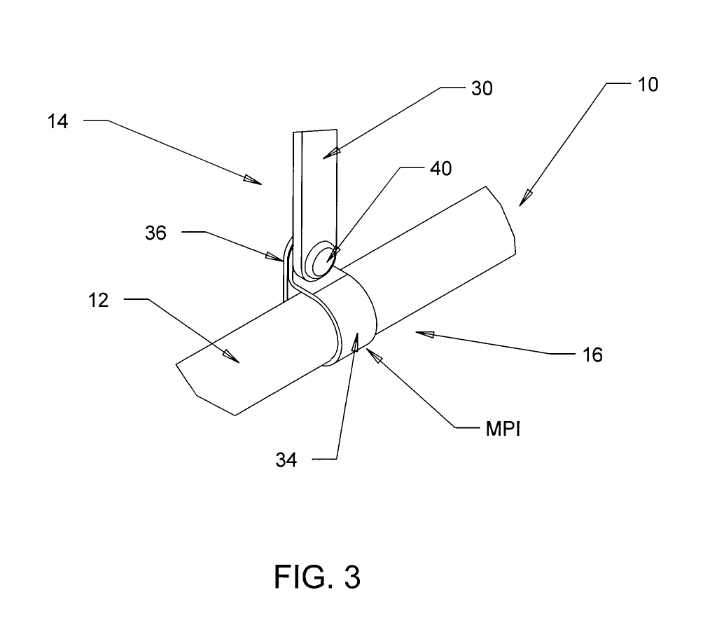

With continued reference to FIG. 2, the collar 16 is provided to operably couple a lower axial end of the elongate portion 30 of the handle 14 that is opposite to the grip portion 32 to the press bar 12 so that the handle 14 can both be deployed in a position in which the grip portion 32 thereof is conveniently accessible (i.e., when the press bar 12 is deployed in the door securing position) and such that the handle 14 can be reliably and conveniently repositioned relative to the press bar 12 (i.e., when the security device 10 is to be deployed in a stowed or storage position). In the one embodiment of the security device 10, the collar 16 includes a band portion 34 extending in encircling relationship around the press bar 12 and having an inner diameter slightly larger than the outer diameter of the press bar 12. The band portion 34 also includes a tab 36 having a bore 38. A bolt 40 passes through a connecting bore 42 formed in the lower axial end of the elongate portion 30 of the handle 14 and the bolt 40 is threadably secured in the bore 38 of the band portion 34 of the collar 16 in a manner such that the handle 14 can pivot about the axis of the bolt 40 relative to the press bar 12. As seen in FIG. 3, which is an enlarged perspective view of a portion of the security device 10 shown in FIG. 2, the bolt 40 extends through the connecting bore 42 in the elongate portion 30 of the handle 14 and is threadably secured in the bore 38 of the band portion 34 of the collar 16.

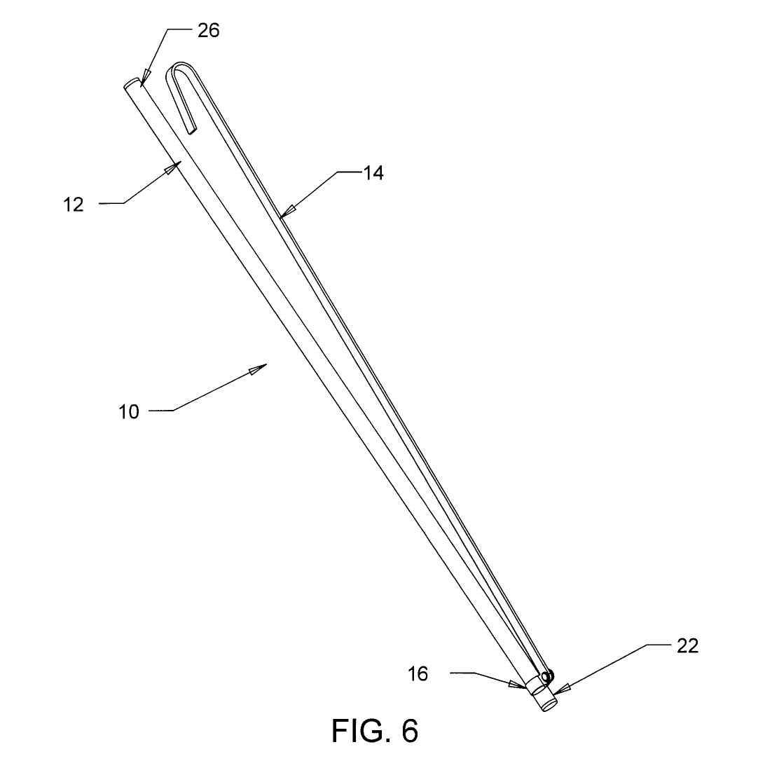

With reference now to FIG. 6, which is a perspective view of the security device 10 in its stowed or storage position, it can be seen that the collar 16 is deployed relatively adjacent a respective one of the axial ends 22, 26 of the press bar 12 when the security device 10 in its stowed or storage position. Additionally, when the security device 10 in its stowed or storage position, the elongate portion 30 of the handle 14 is disposed parallel to, or substantially parallel to, the longitudinal extent of the press bar 12. The respective positions of the collar 16 and the handle 14 relative to the press bar 12 in the stowed or storage position of the security device 10 will be better understood in the following discussion of the operation of the security device 10 in its door securing position and its stowed or storage position.

With reference now to FIG. 4 which shows the patio door 18 in its closed position, the door securing position of the security device 10 will now be explained in further detail. The patio door 18 operates in a conventional or known manner to provide selected access through an aperture in a wall 44 of a building or a residence. Thus, the patio door 18 comprises a parallelepiped aluminum frame 46 coextensive with the borders of the aperture in the wall 44 and has a threshold 48 supporting an inside track 50 in which the sliding door pane 20 is mounted for sliding movement along the inside track 50 for sliding movement along the inside track 50 and an outside track 52 (shown in FIG. 5) which provides fixed, non-sliding support of a glass pane member 54 of the patio door 18. The sliding door pane 18 slides from the left hand side as viewed in FIG. 4 to the right hand side to permit access between the sliding door pane 20 and the aperture in the wall 44. In a closed position of the patio door 18, the sliding door pane 20 has been fully slid from right to left, and is conventionally known, the sliding door pane 20 may be secured via a door handle locking assembly 56. The security device 10, in its door securing position as illustrated in FIG. 4, is deployed such that the press bar 12 extends between a right hand vertical edge of the aluminum frame 46 of the patio door 18, with the end cap 28 abutting the aluminum frame, and a right hand edge of the sliding door pane 20, with the end cap 24 at the opposite axial end of the press bar 12 abutting the sliding door pane 20. It can be understood that the press bar 12 is appropriately dimensioned in correspondence with the distance or spacing between the right hand edge of the sliding door pane 20 and the right hand vertical edge of the aluminum frame 46 such that the press bar 12 extends at, at most, an acute angle relative to the threshold of the patio door 18 and is reliably compressively engaged between the aluminum frame 46 and the sliding door pane 20. In this regard, if the end caps 24, 28 of the press bar 12 are formed, for example, of a suitable rubber or polymer material, these end caps 24, 28 may themselves be under constant compression in the deployed condition of the press bar 12 in the door securing position of the security device 10 with the end caps 24, 28 being sufficiently compressed to cooperatively resist dislodgement of the press bar 12 from its door securing position in the event, for example, that the press bar 12, or the security device 10 overall, is inadvertently bumped by a person or an animal.

The longitudinal extent of the handle 14 is selected in correspondence with the longitudinal extent of the press bar 12 such that, with the collar position generally at the mid-point of the longitudinal extent of the press bar 12, the handle 14 leans at an angle toward a respective one of the right hand vertical side of the aluminum frame 46 of the patio door 18 or the right hand edge of the sliding door pane 20—for example, as seen in FIG. 4, the handle 14 leans at an angle toward the vertical side of the aluminum frame 46 of the patio door 18. Moreover, this predetermined length of the handle 14 is selected such that, in its leaning disposition just described, the grip portion 32 of the handle is in a conveniently accessible position such as, for example, a conveniently accessible position generally at the height of the waist of an average height adult.

With continued reference to FIGS. 1-4, the collar 16 is, in the door securing position of the security device 10, deployed generally at the mid-point MPI of the longitudinal extent of the press bar 12 but may, in consideration of the length of the handle 14, be deployed with equal effect at a suitable location along the longitudinal extent of the press bar 12 between its mid-point and a respective one of its axial ends 22, 26. In this regard, the press bar 12 can be seen as having a predetermined length PD comprised of five quintile segments Q1, Q2, Q3, Q4, and Q5 all having the same length. The collar 16 may be positioned, in the door securing position of the security device 10, at any selected one of the five quintile segments Q1, Q2, Q3, Q4, and Q5 to encircle the press bar 12 at the selected location and to provide a fulcrum about which the handle 14 can move to assume its leaning position against the respective one of the right hand vertical side of the aluminum frame 46 of the patio door 18 or the right hand edge of the sliding door pane 20. In the position of the collar 16 shown in FIG. 3, the collar 16 is at the mid-point MPI of the longitudinal extent of the press bar 12 which is located in the quintile segment Q3.

In the door securing position of the security device 10 shown in FIG. 4, the press bar 12 resists undesired or unauthorized sliding movement of the sliding door pane 20 from the left to the right. Moreover, if the elongate portion 30 of the handle 14 is formed of a predetermined material coordinated with the patio door 18, the visual impact of the security device 10 can be aesthetically minimized. For example, if the elongate portion 30 of the handle 14 is formed of a clear or transparent material such as, for example, a clear acrylic material, the visual impact of the elongate portion 30 relative to the clear glass pane of the non-sliding portion 54 of the patio door 18 is minimized. Alternatively, the elongate portion 30 of the handle 14 and, as well, the grip portion 32, can be formed of a material having a color that is coordinated with the color of the aluminum frame 46 of the patio door and/or of a door trim material.

With reference now to FIGS. 1-5, the change of the security device 10 from its door securing position to its stowed or storage position will now be explained. To release the security device 10 from its door securing position shown in FIG. 4, a user simply grasps the grip portion 32 of the handle 14 of the security device 10, which is, as noted, in a conveniently accessible position, and exerts a pulling or tugging force having a vertically upward component, whereupon the handle 14, acting via its securement with the press bar 12 by the collar 16, effects dislodgement of the press bar 12 from its compressed engagement between the aluminum frame 46 and the sliding door pane 20 of the patio door 18. The user thereafter moves or displaces the collar 16 and the press bar 12 relative to one another to effect a relocation of the collar 16 to a new location. Simultaneous with, or following, the relocation of the collar 16 along the press bar 12, the user may pivot the handle 14 about the bolt 40 relative to the press bar 12 to relocate the handle 14 to a position that is at a lesser acute angle relative to the press bar 12 than the respective acute angle of the handle 14 relative to the press bar 12 when the grip portion 32 of the handle 14 of the security device 10 is in a conveniently accessible position during securement of the patio door 18 in its closed position. Moreover, if desired, the user may place the security device 10 against trim molding around the patio door 18, for example, or, as seen in FIG. 5, may drape the grip portion 32 of the handle 14 upon a peg 62 extending from the wall 44.

With reference again to FIGS. 1,3 and 4, if the user desires to relocate the handle 14 to a position that is at a lesser acute angle relative to the press bar 12 than the respective acute angle of the handle 14 relative to the press bar 12 when the grip portion 32 of the handle 14 of the security device 10 is in a conveniently accessible position during securement of the patio door 18 in its closed position, the user can also displace the collar 16 to a new location on the press bar 12 to optimally obtain a compact folded-up configuration of the security device 10. In this regard, to optimally obtain a compact folded-up configuration of the security device 10, it is preferable that the user displace the collar 16 from the respective quintile segment location it occupies during the door securing position of the security device 10 to a fold up ready location that is in a contiguous one of the five quintile segments Q1, Q2, Q3, Q4, and Q5 contiguous to the “original” quintile segment location. Also, it is most preferable, that the user displace the collar 16 from the respective quintile segment location it occupies during the door securing position of the security device 10 to a fold up ready location that is not contiguous to the original quintile segment Q1, Q2, Q3, Q4, and Q5 but is, instead, separated from the original quintile segment Q1, Q2, Q3, Q4, and Q5 by at least one intermediate quintile segment Q1, Q2, Q3, Q4, and Q5. Thus, as shown in FIG. 3, if, in the security device 10 is in its door securing position, the collar 16 is at the mid-point MPI of the longitudinal extent of the press bar 12 (i.e., located in an “original” quintile segment Q3), it is preferable to displace the collar 16 to a respective one of the quintile segments Q1 (delimiting the axial end 22 of the press bar 12) or Q5 (delimiting the axial end 26 of the press bar 12) as each of these quintile segments Q1 and Q5 is separated from the “original” quintile segment Q3 by a respective “intermediate” quintile segment Q2 or Q4. A displacing movement of the collar 16 in this manner will beneficially reduce the overall length of the combined press bar 12 and the handle 14 when the security device 10 is placed in a folded up condition for stowage or storage.

It can thus be understood that the collar 16 can be formed of any desired material or configuration that permits support of the handle 14 of the security device 10 in a leaning position against a door frame or a vertical edge of a sliding portion of a door when the security device 10 is in its door securing position and, further, which is capable of being relocated relative to the press bar 12 such that the security device 10 can be disposed in its stowed or storage position. Thus, the collar 16 need not necessarily be formed of a band 34 in encircling relationship with the press bar 12 but can, instead, be formed alternatively of a partial band that extends in partially encircling relationship about a portion of the press bar 12. In this regard, with such a partial encircling band, the partial encircling band may be provided with, for example, tabs that travel within longitudinal grooves correspondingly formed in the press bar 12 parallel to its longitudinal axis LA. Additionally, the interconnection between the handle 14 and the collar 16 can be formed of any suitable structure permitting the necessary relative movements between the handle 14 and the collar 16 in lieu of the structure including the bolt 40 described hereinabove.

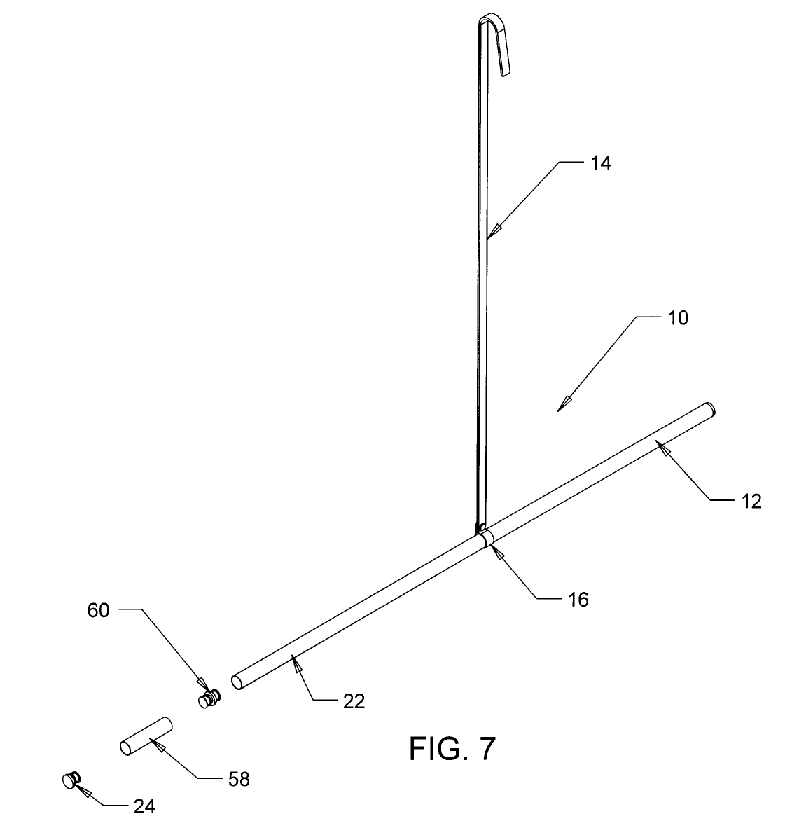

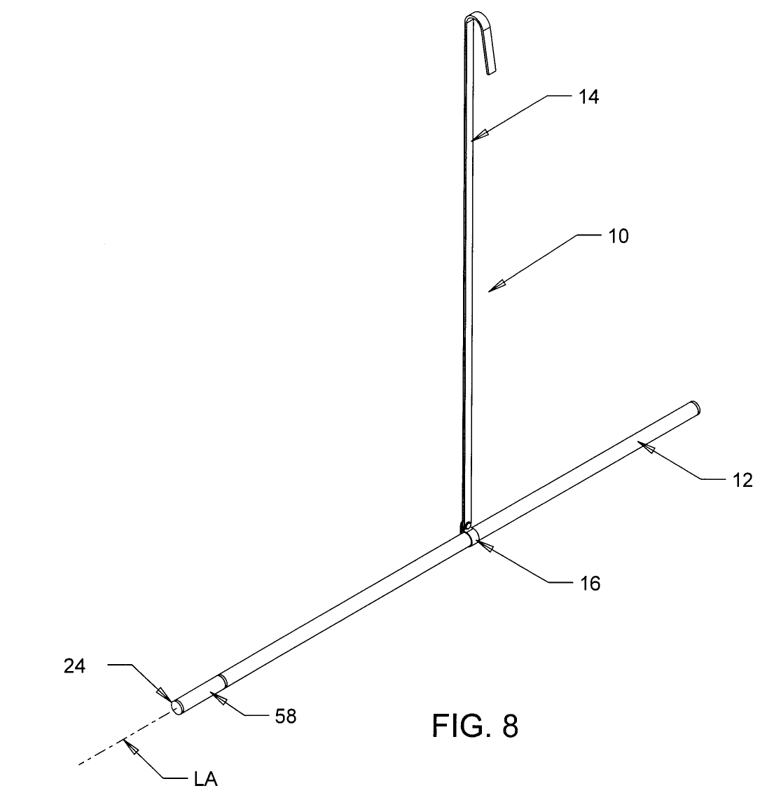

With reference now to FIG. 7, which is a partially exploded perspective view of another embodiment of the security device of the present invention, the security device 10 of this embodiment comprises the same components as the security device 10 described with respect to FIGS. 1-5 and is additionally provided with an extender portion on the axial end 22 of the press bar 12. The extender portion is comprised of a rod segment 58 and a coupling plug 60. The coupling plug 60 is received in the axial end 22 of the press bar 12 and is received as well in one axial end of the rod segment 58. The end cap 24 is received in the opposite axial end of the rod segment 58. Thus, as seen in FIG. 8, which is a perspective view of the another embodiment of the security device 10 in its assembled condition, the extender portion extends the overall length of the press bar 12 as measured along its longitudinal axis LA. This embodiment of the security device 10 thus provides flexibility to initially deploy the security device 10 on a first patio door having a first predetermined spacing between a vertical side of its aluminum frame and an opposed vertical side of its sliding door pane and to thereafter deploy the security device 10 on a second patio door having a different predetermined spacing between a vertical side of its aluminum frame and an opposed vertical side of its sliding door pane than the first patio door.

The security device 10 thus provides an ergonomically favorable configuration that reduces the need for a user to stoop or bend to dispose the press bar 12 in its door securing position or to release the press bar 12 from its door securing position. Moreover, the security device 10 provides a compact configuration in its stowed or storage position which facilitates convenient storage of the security device 10 and, additionally, facilitates storage of the security device 10 in a disposition in which a user can conveniently grasp the security device to deploy the security device in its door securing position relative to a patio door.

While the disclosure of the embodiments herein reference a sliding door, it should be recognized that the door could be a framed door with glass panel, a solid door such as a cabinet door, a garage door, a sliding panel on a window. Additionally, while a particular embodiment of this invention has been shown and described in connection with a sliding glass door, this is by way of illustration only and does not constitute any sort of limitation since there are various alterations, changes, deviations, amendments, revisions, eliminations, additions, substitutions, omissions and departures which may be made in the present illustration and other types of sliding glass door arrangements with which the present invention can be used without departing from the scope of this invention as defined only by a proper interpretation of the appended claims.

1-4. (canceled)

5. A security device for securing a sliding closure movable in one direction against one aperture frame and movable in an opposite direction toward an opposed aperture frame, the security device comprising:
a handle;
a press bar, the press bar being disposable between the sliding closure and the opposed aperture frame and the handle promoting release of the press bar from its disposition between the sliding closure and the opposed aperture frame when a force is applied to the handle; and
a fulcrum component for interconnecting the handle and the press bar to one another, the fulcrum component being positionable between a first position relative to the press bar when the security device is in a sliding closure movement preventing position and a second position relative to the press bar when the security device in a stowage position, and the handle being movable between a release ready position in which the handle rests against a respective one of the sliding closure or the opposed aperture frame at a respective acute angle and a stowage position in the handle is at a lesser acute angle relative to the press bar than the respective acute angle of the handle relative to the respective one of the sliding closure or the opposed aperture frame when the security device is in its sliding closure movement preventing position.

6. A security device for securing a sliding closure according to claim 5, wherein the fulcrum component includes a pivot element about which the handle pivots.

7. A security device for securing a sliding closure according to claim 5, wherein the handle is formed of a non-opaque material.

8. A security device for securing a sliding closure according to claim 7, wherein the handle is formed with a grip portion in the shape of an inverted letter “J”.
